(19) United States
(12) Patent Application Publication
(10) Pub. No.: US 2025/0069789 A1
(43) Pub. Date: Feb. 27, 2025

(54) COIL COMPONENT

(71) Applicant: SAMSUNG ELECTRO-MECHANICS CO., LTD., Suwon-si (KR)

(72) Inventors: Dong Jin LEE, Suwon-si (KR); Soon KWANG KWON, Suwon-si (KR); Dong Hwan LEE, Suwon-si (KR); Tae Hyun KIM, Suwon-si (KR); Byeong Cheol MOON, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/645,805

(22) Filed: Apr. 25, 2024

(30) Foreign Application Priority Data
Aug. 22, 2023 (KR) 10-2023-0109908

(51) Int. Cl. H01F 5/00; H01F 5/04; H01F 27/29

(52) U.S. Cl. CPC H01F 5/003; H01F 5/04; H01F 27/292

(57) ABSTRACT

A coil component, may include: a body including a first surface and a second surface facing each other in a first direction, and a third surface connecting the first surface and the second surface; a support member disposed within the body; a coil disposed on the support member, and including a coil pattern having at least one turn and a lead-out portion extending from an outer end of the coil pattern to the first surface or the second surface; and an electrode 10 portion extending from the lead-out portion externally of the body and disposed on the body, and having an average thickness smaller than the average thickness of the lead-out portion.

### CROSS-REFERENCE TO RELATED APPLICATION(S)

This application claims the benefit of priority to Korean Patent Application No. 10-2023-0109908 filed on Aug. 22, 2023 in the Korean Intellectual Property Office, the disclosure of which is incorporated herein by reference in its entirety.

### TECHNICAL FIELD

The present disclosure relates to a coil component.

### BACKGROUND

An inductor, a coil component, is a representative passive electronic component used in electronic devices along with resistors and capacitors.

As electronic devices are increasingly implemented with high-performance and are miniaturized, electronic components used in electronic devices are also increasing in number and becoming smaller.

Meanwhile, in the case of a thin film-type coil component obtained by forming a coil on a support member by plating, it may be advantageous for miniaturization but there may be a problem in that bonding force between an external electrode and a coil may be reduced, so that there is a demand for a structure that can maintain reliability of a connection between the coil and the external electrode despite vibration or impacts.

### SUMMARY

An aspect of the present disclosure is to provide a coil component that can maintain reliability of a connection between a coil and an external electrode within the coil component despite vibrations or external impacts.

Another aspect of the present disclosure is to strengthen physical bonding force between an electrode portion and a body through a structure in which the electrode portion is bent to surround the body.

According to an aspect of the present disclosure, a coil component may include: a body including a first surface and a second surface facing each other in a first direction, and a third surface connecting the first surface and the second surface; a support member disposed within the body; a coil disposed on the support member, and including a coil pattern having at least one turn and a lead-out portion extending from an outer end of the coil pattern to the first surface or the second surface; and an electrode portion extending from the lead-out portion externally of the body and disposed on the body, and having an average thickness smaller than an average thickness of the lead-out portion.

According to another aspect of the present disclosure, a coil component may include: a body, a first coil and a second coil disposed within the body and having at least one turn, a first electrode portion and a second electrode portion extending from both ends of the first coil externally of the body, respectively, and disposed on the body, and a third electrode portion and a fourth electrode portion extending from both ends of the second coil externally of the body, respectively, and disposed on the body, in which an average thickness of each of the first electrode portion and the second electrode portion is smaller than an average thickness of the first coil, and an average thickness of each of the third electrode portion and the fourth electrode portion is smaller than an average thickness of the second coil.

According to still another aspect of the present disclosure, a coil component may include: a body, a support member disposed within the body, a coil disposed on the support member within the body and having at least one turn, and an electrode portion extending from a lead-out portion of the coil externally of the body and disposed on an external surface of the body to function as an external electrode, in which the electrode portion includes a reduced thickness portion at the one end of the coil, and the electrode portion is integrally formed with the lead-out portion.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to a first embodiment of the present disclosure;

FIG. 2 is a cross-sectional view taken along line I-I′ of FIG. 1 and an enlarged view of left and right sides;

FIG. 3 is a cross-sectional view taken along line II-II′ of FIG. 1;

FIG. 4A is a right side view of FIG. 1, and FIGS. 4B, 4C, and 4D are modified examples of FIG. 4A;

FIG. 5 is a diagram corresponding to FIG. 2 as a first modified example of the coil component according to the first embodiment of the present disclosure;

FIG. 6 is a second modified example of the coil component according to the first embodiment of the present disclosure, and is a diagram corresponding to FIG. 5;

FIG. 7 is a perspective view schematically illustrating a coil component according to a second embodiment of the present disclosure;

FIG. 8A is a bottom view of FIG. 7, and FIGS. 8B, 8C, 8D, and 8E are modified examples of FIG. 8A;

FIG. 9 is a perspective view schematically illustrating a coil component according to a third embodiment of the present disclosure;

FIG. 10 is an exploded perspective view illustrating a connection relationship between the coils of FIG. 9;

FIG. 11 is a left side view of FIG. 9;

FIG. 12 is a right side view of FIG. 9;

FIG. 13 is a process diagram schematically illustrating operations for forming a coil of the coil component according to the first embodiment of the present disclosure;

FIG. 14 is a process diagram schematically illustrating operations for forming a body of the coil component according to the first embodiment of the present disclosure; and

FIG. 15 is a process diagram schematically illustrating a bending operation of an electrode portion of the coil component according to the first embodiment of the present disclosure.

### DETAILED DESCRIPTION

The terms used in the present application are only used to describe specific embodiments, and are not intended to limit the present disclosure. The singular expression includes the plural expression unless the context clearly dictates otherwise. In the present application, terms such as “comprise” or “have” are intended to designate that a feature, number, operation, operation, component, part, or combination thereof described in the specification exists, and it should be understood that this does not preclude the possibility of addition or existence of one or more other features or numbers, operations, operations, components, parts, or combinations thereof. Throughout the specification, “on” means to be positioned above or below the target part, and does not necessarily mean to be positioned on the upper side with respect to the direction of gravity.

In addition, the term “coupling” does not mean only a case of direct physical contact between respective components in the contact relationship between respective components, and is used as a concept that encompasses even the case in which other components are interposed between respective components and the components are respectively in contact with the other components.

The size and thickness of each component illustrated in the drawings are arbitrarily indicated for convenience of description, and thus, the present disclosure is not necessarily limited to the illustration.

In the drawings, an L direction may be defined as a first direction or a length direction, a W direction may be defined as a second direction or a width direction, and a T direction may be defined as a third direction or a thickness direction.

Hereinafter, a coil component according to an embodiment will be described in detail with reference to the accompanying drawings, and in the description with reference to the accompanying drawings, the same or corresponding components are given the same reference numerals, and the overlapping description thereof will be omitted.

Various types of electronic components are used in electronic devices, and among these electronic components, various types of coil components may be appropriately used for noise removal and the like.

For example, in electronic devices, the coil component may be used as a power inductor, a high frequency (HF) inductor, a general bead, a high frequency bead (GHz Bead), a common mode filter, or the like.

### First Embodiment

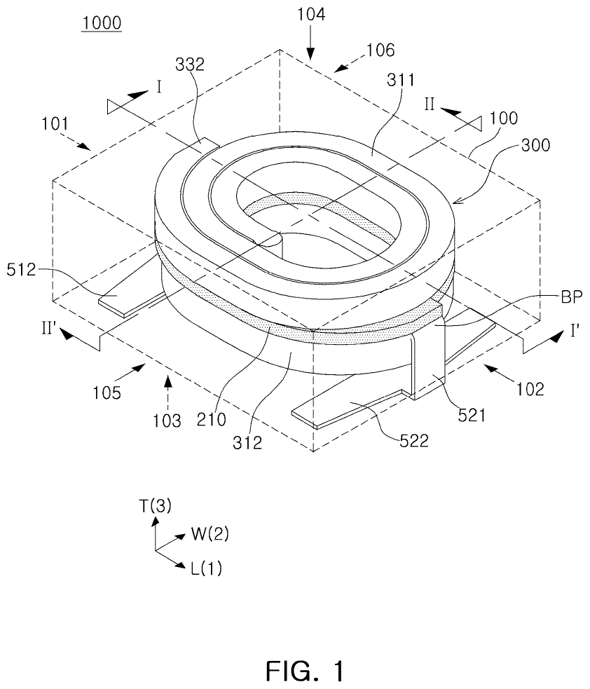

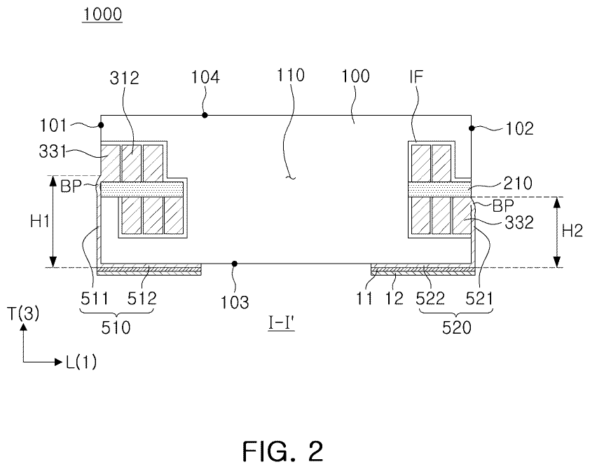

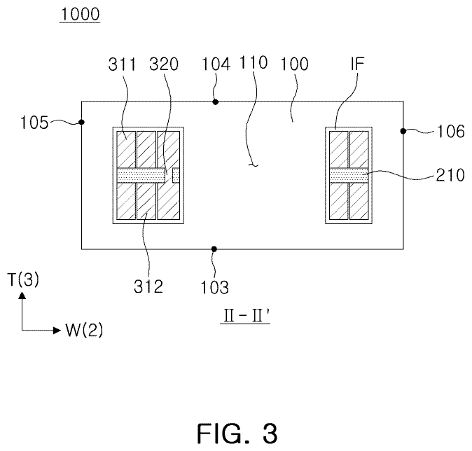

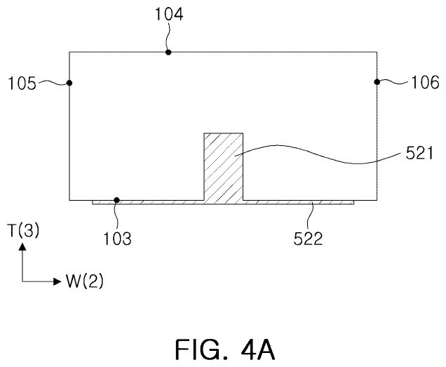

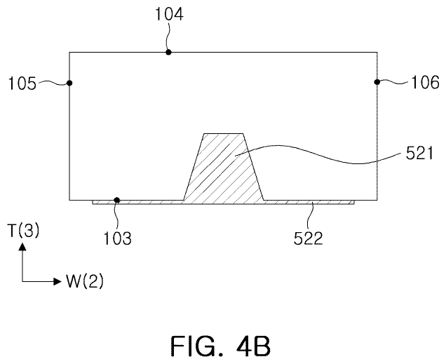

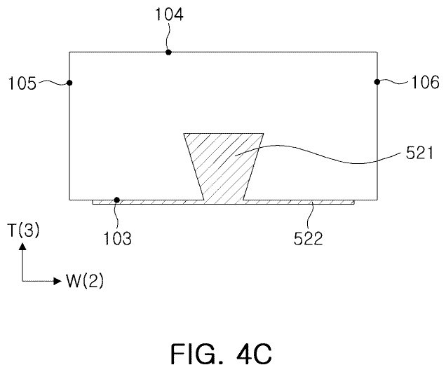

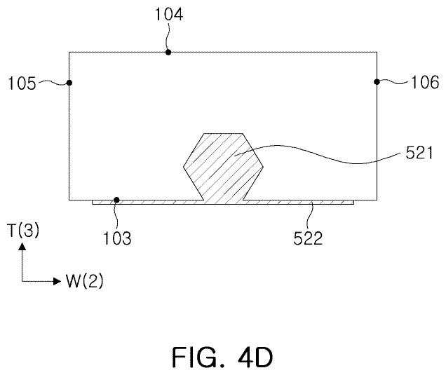

FIG. 1 is a perspective view schematically illustrating a coil component according to a first embodiment of the present disclosure. FIG. 2 is a cross-sectional view taken along line I-I′ of FIG. 1 and an enlarged view of left and right sides. FIG. 3 is a cross-sectional view taken along line II-II′ of FIG. 1. FIG. 4A is a right side view of FIG. 1, and FIGS. 4B to 4D are modified examples of FIG. 4A.

Meanwhile, in order to more clearly illustrate bonding between components, an insulating layer on a body that can be applied to the present disclosure are omitted and illustrated.

Referring to FIGS. 1 to 4, a coil component 1000 according to a first embodiment of the present disclosure may include a body 100, a support member 210, a coil 300, and first and second electrode portions 510 and 520.

A coil component 1000 according to the present embodiment may include first and second electrode portions 510 and 520, not including a separate external electrode, integrally formed with the coil and extending from the coil 300 externally of the body 100, and bent along a side surface and a lower surface of the body 100.

Accordingly, as compared to the structure in which a separate external electrode is connected to the coil 300, bonding force between the coil 300 and the external electrode may be improved, and due to a structure in which the first and second electrode portions 510 and 520 are bent to surround the body 100, physical bonding force between the first and second electrode portions 510 and 520 and the body 100 may also be strengthened.

Accordingly, the coil component 1000 according to the present embodiment may have an effect in which reliability of a connection between the coil 300 and the first and second electrode portions 510 and 520 is maintained even in the event of external impact or vibration.

Hereinafter, the main components constituting the coil component 1000 according to the present embodiment will be described in detail.

The body 100 forms the exterior of the coil component 1000 according to the present embodiment, and the support member 210 and the coil 300 are buried therein.

The body 100 may be formed to have an overall hexahedral shape.

The body 100 includes a first surface 101 and a second surface 102 facing each other in a length (L) direction (first direction), a third surface 103 and a fourth surface 104 facing each other in a thickness (T) direction (third direction), and a fifth surface 105 and a sixth surface 106 facing each other in a width (W) direction (second direction). Each of the first surface 101, the second surface 102, the fifth surface 105, and the sixth surface 106 of the body 100 corresponds to a wall surface of the body 100 connecting the third surface 103 and the fourth surface 104 of the body 100.

In the body 100, as an example, the coil component 1000 including the first and second electrode portions 510 and 520 according to the present embodiment may be formed to have a length of 2.5 mm, a width of 2.0 mm, and a thickness of 0.8 mm, to have a length of 2.0 mm, a width of 1.2 mm and a thickness of 0.6 mm, to have a length of 1.6 mm, a width of 0.8 mm, and a thickness of 0.6 mm, to have a length of 1.6 mm, a width of 0.8 mm and a thickness of 0.4 mm, to have a length of 1.4 mm, a width of 1.2 mm, and a thickness of 0.65 mm, or to have a length of 1.0 mm, a width of 0.7 mm, and a thickness of 0.65 mm, or to have a length of 0.8 mm, a width of 0.4 mm, and a thickness of 0.65 mm, or to have a length of 0.8 mm, a width of 0.4 mm, and a thickness of 0.5 mm, but the present disclosure is not limited thereto. On the other hand, the above-described exemplary values for the length, width, and thickness of the coil component 1000 refer to values that do not reflect process errors, and the values within the range that may be recognized as process errors should be considered to correspond to the above-described exemplary values.

Based on the optical microscope image or Scanning Electron Microscope (SEM) image of a length direction (L)—thickness direction (T) cross-section taken from a central portion of the coil component 1000 in a width direction (W), the length of the coil component 1000 described above may refer to a maximum value of dimensions of a plurality of respective segments obtained by connecting two outermost boundary lines of the coil component 1000, facing in the length direction (L) of the coil component 1000 illustrated in the image, to each other to be parallel to the length direction (L), and being spaced apart from each other in the thickness direction (T). Alternatively, the length of the coil component 1000 may refer to a minimum value among the dimensions of the plurality of respective line segments described above. Alternatively, the length of the coil component 1000 may refer to an arithmetic mean value of at least three or more of the dimensions of the plurality of respective line segments described above. In this case, the plurality of line segments parallel to the length direction (L) may be equally spaced from each other in the thickness direction (T), but the scope of the present disclosure is not limited thereto.

Based on the optical microscope image or Scanning Electron Microscope (SEM) image of the length direction (L)—thickness direction (T) cross-section taken from the central portion of the coil component 1000 in the width direction (W), the thickness of the coil component 1000 described above may refer to a maximum value of dimensions of a plurality of respective line segments obtained by connecting two outermost boundary lines of the coil component 1000, facing in the thickness direction (T) illustrated in the image, to each other to be parallel to the thickness direction (T), and being spaced apart from each other in the length direction (L). Alternatively, the thickness of the coil component 1000 may refer to a minimum value among the dimensions of the plurality of respective line segments described above. Alternatively, the thickness of the coil component 1000 may refer to an arithmetic mean value of at least three or more of the dimensions of the plurality of respective line segments described above. In this case, the plurality of line segments parallel to the thickness direction (T) may be equally spaced from each other in the length direction (L), but the scope of the present disclosure is not limited thereto.

Based on the optical microscope image or Scanning Electron Microscope (SEM) image of the length direction (L)—width direction (W) cross-section taken from the central portion of the coil component 1000 in the thickness direction (T), the width of the coil component 1000 described above may refer to a maximum value among dimensions of a plurality of respective line segments, which are provided by connecting two outermost boundary lines of the coil component 1000, facing in the width direction (W), illustrated in the image, to be parallel to the width direction (W), and being spaced apart from each other in the length direction (L). Alternatively, the width of the coil component 1000 may refer to a minimum value among the dimensions of the plurality of respective line segments described above. Alternatively, the width of the coil component 1000 may refer to an arithmetic mean value of at least three or more of the dimensions of the plurality of respective line segments described above. In this case, the plurality of line segments parallel to the width direction (W) may be equally spaced from each other in the length direction L, but the scope of the present disclosure is not limited thereto.

Alternatively, each of the length, width, and thickness of the coil component 1000 may be measured by a micrometer measurement method. The micrometer measurement method may be performed by setting the zero point with a gage Repeatability and Reproducibility (R&R) micrometer, inserting the coil component 1000 according to this embodiment between the tips of the micrometer and turning the measuring lever of the micrometer. On the other hand, in measuring the length of the coil component 1000 by the micrometer measurement method, the length of the coil component 1000 may refer to a value measured once, and may also refer to an arithmetic mean of values measured multiple times. This may equally be applied to the width and thickness of the coil component 1000.

The body 100 may include a magnetic material and a resin. In detail, the body 100 may be formed by laminating one or more magnetic composite sheets in which a magnetic material is dispersed in a resin. However, the body 100 may have a structure other than a structure in which a magnetic material is dispersed in a resin. For example, the body 100 may be formed of a non-magnetic material such as ferrite.

The magnetic material may be ferrite or magnetic metallic powder.

Ferrite may be at least one of, for example, spinel-type ferrites such as Mg—Zn, Mn—Zn, Mn—Mg, Cu—Zn, Mg—Mn—Sr, Ni—Zn, and the like, hexagonal ferrites such as Ba—Zn, Ba—Mg, Ba—Ni, Ba—Co, and Ba—Ni—Co, and the like, garnet-type ferrites such as Y and the like, and Li ferrites.

The magnetic metal powder may include at least one or more selected from the group consisting of iron (Fe), silicon (Si), chromium (Cr), cobalt (Co), molybdenum (Mo), aluminum (Al), niobium (Nb), copper (Cu), boron (B), zirconium (Zr), hafnium (Hf), phosphorus (P), and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr alloy powder, and Fe—Cr—Al alloy powder.

The magnetic metal powder may include amorphous and/or crystalline. For example, the magnetic metal powder may be an Fe—Si—B—Cr-based amorphous alloy powder, but is not limited thereto.

Each of ferrite and magnetic metal powder may have an average diameter of about 0.1 μm to 30 μm, but the present disclosure is not limited thereto.

The body 100 may include two or more types of magnetic materials dispersed in a resin. In this case, the different types of magnetic materials mean that the magnetic materials dispersed in the resin are distinguished from each other by any one of an average diameter, composition, crystallinity, and shape.

The resin may include, but is not limited to, epoxy, polyimide, a liquid crystal polymer, or the like, alone or in combination.

The body 100 has a core 110 penetrating the support member 200 and the coil 300. The core 110 may be formed by filling a through-hole of the support member 210 with a magnetic composite sheet, but the present disclosure is not limited thereto.

The support member 210 may be disposed within the body 100. The support member 210 is a component to support the coil 300. Meanwhile, the support member 210 may be excluded depending on the embodiment, such as when the coil 300 corresponds to a wound coil or has a coreless structure.

The support member 210 may be formed of an insulating material including a thermosetting insulating resin such as an epoxy resin, a thermoplastic insulating resin such as polyimide, or a photosensitive insulating resin, or may be formed of an insulating material impregnated with a reinforcing material such as glass fiber or an inorganic filler in this insulating resin. For example, the support member 210 may include a Prepreg, Ajinomoto Build-up Film (ABF), FR-4, Bismaleimide Triazine (BT) resin, Photo Imageable Dielectric (PID), and the like, but the present disclosure is not limited thereto.

As an inorganic filler, at least one selected from the group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used.

When the support member 210 is formed of an insulating material including a reinforcing material, the support member 210 may provide more excellent rigidity. When the support member 210 is formed of an insulating material that does not contain glass fibers, it may be advantageous to reduce the overall thickness of the support member 210 and the coil 300 (meaning a sum of dimensions of the coil 300 and the support member 210 in the thickness direction (T) in FIG. 1) to reduce the component. When the support member 210 is formed of an insulating material including a photosensitive insulating resin, since the number of processes for forming the coil 300 is reduced, it may be advantageous to reduce production costs, and a fine via 320 may be formed. A thickness of the support member 210 may be, for example, 10 μm or more and 50 μm or less, but is not limited thereto.

The coil 300 is disposed on the support member 210. The coil 300 is buried in the body 100 and exhibits the characteristics of a coil component. For example, when the coil component 1000 according to the present embodiment is used as a power inductor, the coil 300 stores the electric field as a magnetic field to maintain an output voltage, thereby stabilizing the power of an electronic device.

The coil 300 is formed on at least one of both surfaces of the support member 210, facing each other, and forms at least one turn. In the present embodiment, the coil 300 may include coil patterns 311 and 312, a via 320, and first and second lead-out portions 331 and 332.

In addition, the first and second electrode portions 510 and 520, to be described later, may extend integrally from the first and second lead-out portions 331 and 332 and extend externally of the body 100 with a thickness, smaller than that of the first and second lead-out portions 331 and 332.

Referring to FIGS. 1 to 3, each of the first coil pattern may be disposed on both surfaces of the support member 210, facing each other, and may have a flat spiral shape forming at least one turn centered on the core 110 of the body 100 centered on the core 110 of the body 100. For example, based on the direction of FIG. 1, the first coil pattern 311 is disposed on an upper surface of the support member 210 to form at least one turn centered on the core 110. The second coil pattern 312 is disposed on a lower surface of the support member 210 and forms at least one turn centered on the core 110. Each of the first and second coil patterns 311 and 312 is formed in a form in which an end of the outermost turn connected to the first and second lead-out portions 331 and 332 extends in a direction of the first surface 101 and the second surface 102 of the body 100, respectively.

Referring to FIGS. 1 to 3, the first and second lead-out portions 331 and 332 may extend from the coil patterns 311 and 312 to the first surface 101 or the second surface 102 of the body 100.

Specifically, the first lead-out portion 331 may be connected to the first electrode portion 510, extending from an outer end of the first coil pattern 311 to the first surface 101 of the body 100, and extending externally of the body 100 to be bent. However, the first lead-out portion 331 and the first electrode portion 510 may have a structure that is integrally formed and connected to each other only with different thicknesses.

Likewise, the second lead-out portion 332 may be connected to the second electrode portion 520, extending from an outer end of the second coil pattern 312 to the second surface 102 of the body 100, and extending externally of the body 100 to be bent. However, the second lead-out portion 332 and the second electrode portion 520 may have a structure that is integrally formed and connected to each other only with different thicknesses.

Referring to FIG. 3, the coil 300 may further include a via 320 connecting the first coil pattern 311 and the second coil pattern 312. Specifically, the via 320 may penetrate the support member 210 and connect inner ends of innermost turns of each of the first and second coil patterns 311 and 312 to each other. Accordingly, a signal input to the first electrode portion 510 may be output to the second electrode portion 520 through the first lead-out portion 331, the first coil pattern 311, the via 320, the second coil pattern 312, and the second lead-out portion 332. By this structure, respective components of the coil 300 may function as a whole as one coil connected between the first and second electrode portions 510 and 520.

At least one of the coil patterns 311 and 312, the via 320, and the first and second lead-out portions 331 and 332 may include at least one or more conductive layers.

For example, when the first coil pattern 311, the via 320, and the first lead-out portion 331 are formed by plating on the upper surface of the support member 210 (based on the direction of FIG. 1), each of the first coil pattern 311, the via 320, and the first lead-out portion 331 may include a seed layer and an electroplating layer. The seed layer may be formed by electroless plating or vapor deposition methods such as sputtering. Each of the seed layer and the electroplating layer may have a single-layer structure or a multilayer structure. The electroplating layer with a multilayer structure may be formed with a conformal film structure in which one electroplating layer is covered by another electroplating layer, and may also be formed in a shape in which another electroplating layer is laminated on only one surface of one electroplating layer. A seed layer of the first coil pattern 311, a seed layer of the via 320, and a seed layer of the first lead-out portion 331 may be integrally formed, so that no boundary is formed therebetween, but the present disclosure is not limited thereto. An electroplating layer of the first coil pattern 311, an electroplating layer of the via 320, and an electroplating layer of the first lead-out portion 331 may be integrally formed so that no boundary is formed therebetween, but the present disclosure is not limited thereto.

Each of the coil patterns 311 and 312, the via 320, and the first and second lead-out portions 331 and 332 may include a conductive material such as copper (Cu), aluminum (Al), silver (Ag), tin (Sn), gold (Au), and nickel (Ni), lead (Pb), titanium (Ti), chromium (Cr), molybdenum (Mo), or alloys thereof, but the present disclosure is not limited thereto.

In addition, the first and second electrode portions 510 and 520 integrated with the first and second lead-out portions 331 and 332 may also include the above-described conductive material.

Referring to FIGS. 1 and 2, the first and second electrode portions 510 and 520 may extend from the first and second lead-out portions 331 and 332 externally of the body 100 and be disposed on the body 100, and may be formed with an average thickness, smaller than an average thickness of the first and second lead-out portions 331 and 332.

Since the first and second lead-out portions 331 and 332 have substantially the same thickness as the coil patterns 311 and 312, an operation region in which the thickness thereof changes discontinuously between the first and second lead-out portions 331 and 332 and the first and second electrode portions 510 and 520 may be formed.

In addition, the average thickness of the first and second electrode portions 510 and 520 may be formed to be smaller than the average thickness of the support member 210. For example, the average thickness of the support member 210 may be 68 μm, and the average thickness of the first and second electrode portions 510 and 520 may be 30 μm, but the present disclosure is not limited thereto.

In this case, based on the optical microscope image or Scanning Electron Microscope (SEM) image of the length direction (L)—thickness direction (T) cross-section taken from the central portion of the coil component 1000 in the width direction (W), the average thickness of the first and second lead-out portions 331 and 332 or the support member 210 may refer to an arithmetic mean value of at least three or more of dimensions of a plurality of respective line segments obtained by connecting two outermost boundary lines of the support member 210, which face in the thickness direction (T) of the first and second lead-out portions 331 and 332 or the support member 210 illustrated in the image, to each other to be parallel to the thickness direction (T) and which are spaced apart from each other in the length direction (L). In this case, the plurality of line segments may be equally spaced from each other, but the scope of the present disclosure is not limited thereto.

In addition, based on the optical microscope image or Scanning Electron Microscope (SEM) image of the length direction (L)—thickness direction (T) cross-section taken from the central portion of the coil component 1000 in the width direction (W), the average thickness of the first and second electrode portions 510 and 520 may refer to an arithmetic mean value of at least three or more of dimensions of a plurality of respective line segments obtained by connecting two outermost boundary lines of the first and second electrode portions 510 and 520, which face in the length direction (L) of the first and second electrode portions 510 and 520 illustrated in the image, to each other to be parallel to the length direction (L) and which are spaced apart from each other in the thickness direction (T). In this case, the plurality of line segments may be equally spaced from each other, but the scope of the present disclosure is not limited thereto.

Referring to FIG. 2, the first and second electrode portions 510 and 520 may be integrally formed with the first and second lead-out portions 331 and 332, so that a boundary therebetween may not appear. That is, the first electrode portion 510 may be integrally formed with the first lead-out portion 331 without an interface, and the second electrode portion 520 may be integrally formed with the second lead-out portion 332 without an interface.

Referring to FIG. 2, the first and second electrode portions 510 and 520 may be directly connected to the first and second lead-out portions 331 and 332, and include extension portions 511 and 521 disposed on the first surface 101 or the second surface 102 of the body 100, and pad portions 512 and 522 disposed on the third surface 103 thereof.

The extension portions 511 and 521 and the pad portions 512 and 522 may be integrally formed with each other and may be connected without an interface.

Referring to FIGS. 1 and 2, the extension portions 511 and 521 may include a bent portion BP bent toward the third surface 103 of the body 100 in a region thereof in contact with the extension portions 331 and 332, and an outer surface of the bent portion BP may include a curved surface.

The bent portion BP of the present embodiment corresponds to a feature resulting from a process in which the first and second electrode portions 510 and 520 are integrally formed from the first and second lead-out portions 331 and 332 and bent downwardly to be in close contact with the surface of the body 100. Accordingly, the outer surface of the bent portion BP may be formed in a rounded shape.

Referring to FIG. 2, the first extension portion 511 may extend externally of the first lead-out portion 331 and be disposed on the first surface 101 of the body 100.

Likewise, the second extension portion 521 may extend externally of the second lead-out portion 332 and be disposed on the second surface 102 of the body 100.

Referring to FIG. 2, an average length H1 of the first extension portion 511 may be different from an average length H2 of the second extension portion 521, and the average length H1 of the first extension portion 511 may be longer than the average length H2 of the second extension portion 521.

The above-described feature may correspond to a difference, equal to the sum of the thickness of the support member 210 and the thicknesses of the first and second electrode portions 510 and 520 as the extension portions 511 and 521 extending from the respective first and second lead-out portions 331 and 332 are bent downwardly and are disposed on the body 100.

In this case, based on the optical microscope image or Scanning Electron Microscope (SEM) image of the length direction (L)—thickness direction (T) cross-section taken from the central portion of the coil component 1000 in the width direction (W), the average length of the extension portions 511 and 512 may refer to an arithmetic mean value of at least three or more of dimensions of a plurality of respective line segments obtained by connecting two uppermost and lowermost boundary lines of the extension portions 511 and 512, which face in the thickness direction (T) of the extension portions 511 and 512 illustrated in the image, to each other to be parallel to the thickness direction (T) and which are spaced apart from each other in the length direction (L). In this case, the plurality of line segments may be equally spaced from each other, but the scope of the present disclosure is not limited thereto.

FIG. 4A is a right side view of FIG. 1, and FIGS. 4B to 4D are modified examples of FIG. 4A.

Referring to FIG. 4A, extension portions 511 and 521 of the present embodiment may have a constant width in a second direction W. For example, the extension portions 511 and 521 may have a rectangular shape based on the W-T cross-section.

However, the scope of the present disclosure is not limited thereto, and the shape of the extension portions 511 and 521 may be variously modified as follows.

Referring to FIG. 4B, a width of the extension portions 511 and 521 in a second direction W may be maximum in a region in contact with the pad portions 512 and 522. For example, the extension portions 511 and 521 may have a trapezoidal shape based on the W-T cross section.

Alternatively, referring to FIG. 4C, a width of the extension portions 511 and 521 in a second direction W may be minimum in a region in contact with the pad portions 512 and 522. For example, the extension portions 511 and 521 may have an inverted trapezoidal shape based on the W-T cross section.

Alternatively, referring to FIG. 4D, a width of the extension portions 511 and 521 in a second direction W may be maximum in a central region of the extension portions 511 and 521. For example, the extension portions 511 and 521 may have a hexagonal shape based on the W-T cross section.

Referring to FIG. 1, the width of the pad portions 512 and 522 in the second direction W may be maximum in a region, most adjacent to a center of the third surface 103 of the body 100.

In addition, the width of the pad portions 512 and 522 in the second direction W may gradually become greater toward the center of the third surface 103 of the body 100.

In addition, the width of the pad portions 512 and 522 in the second direction W may be formed to be minimum in a region in contact with the extension portions 511 and 512.

As each region of the first and second electrode portions 510 and 520 has the above-described shape, the physical bonding force between the body 100 and the first and second electrode portions 510 and 520 may be strengthened, and the width of the extension portions 511 and 512 may be narrow, so that a risk of short circuit with adjacent components may be reduced when mounting the coil component 1000 according to the present embodiment on a printed circuit board (PCB).

Meanwhile, referring to FIG. 2, the first and second electrode portions 510 and 520 may further include a first metal layer 11 disposed on the pad portions 512 and 522. For example, the first metal layer 11 may be a nickel (Ni) plating layer.

In addition, the first and second electrode portions 510 and 520 may further include a second metal layer 22 disposed on the first metal layer 11. For example, the second metal layer 22 may be a tin (Sn) plating layer.

The first metal layer 11 and the second metal layer 22 may be formed by electroplating, but the present disclosure is not limited thereto.

Referring to FIGS. 2 and 3, an insulating film IF is disposed between the coil 300 and the body 100 to cover the coil 300. The insulating film IF may be formed along surfaces of the support member 210 and the coil 300. The insulating film IF is used to insulate the coil 300 from the body 100, and may include a known insulating material such as parylene, but the present disclosure is not limited thereto. The insulating film IF may be formed by a method such as vapor deposition, but the present disclosure is not limited thereto, and may be formed by laminating an insulating film on both surfaces of the support member 210.

### Modified Examples of First Embodiment

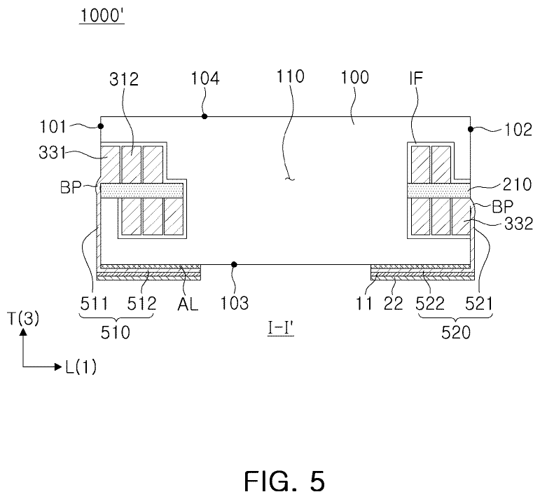

FIG. 5 is a diagram corresponding to FIG. 2 as a first modified example 1000′ of a coil component according to a first embodiment of the present disclosure.

Comparing FIG. 5 with FIG. 2, FIG. 5 is different from FIG. 2 in that an adhesive layer AL disposed between the body 100 and the pad portions 512 and 522 is further included.

Therefore, in describing this modified example, only the adhesive layer AL, different from that of the first embodiment of the present disclosure will be described, and the description in the first embodiment of the present disclosure may be applied as it is to the remaining components.

Referring to FIG. 5, the coil component 1000′ according to the present embodiment may further include an adhesive layer AL disposed between the pad portions 512 and 522 and the third surface 103 of the body 100.

The adhesive layer AL is a component that can strengthen the bonding force between the pad portions 512 and 522 and the body 100, and may include epoxy.

The adhesive layer AL may be conductive epoxy containing metal particles, but the present disclosure is not limited thereto, and may be non-conductive epoxy.

Referring to FIG. 5, the adhesive layer AL of the present embodiment is formed of a single layer, but the present disclosure is not limited thereto and may be formed of a plurality of layers.

The adhesive layer AL may be formed in a form of a sheet or paste containing epoxy, but the present disclosure is not limited thereto.

The coil component 1000′ according to the present embodiment may further include an adhesive layer AL disposed between the pad portions 512 and 522 and the third surface 103 of the body 100, so that mechanical properties that can withstand shock or vibration may be improved.

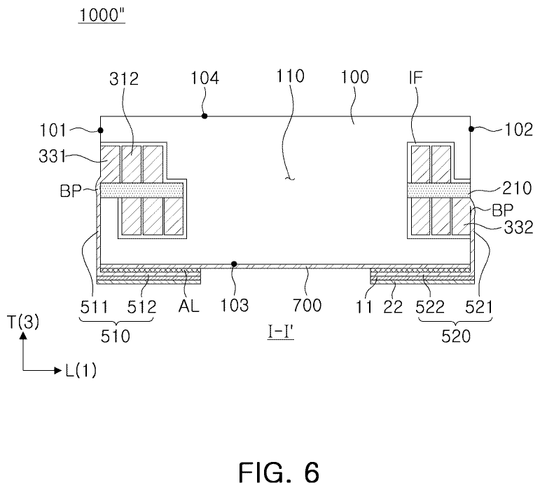

FIG. 6 is a second modified example 1000″ of the coil component according to a first embodiment of the present disclosure.

Comparing FIG. 6 with FIG. 5, FIG. 6 is different from FIG. 5 in that an insulating layer 700 disposed between the third surface 103 of the body 100 and an adhesive layer AL is further included.

Therefore, in describing the present modified example 1000″, only the insulating layer 700, different from that of the first modified example 1000′ of the present disclosure will be described, and for the remaining components, the description in the first embodiment of the present disclosure may be applied as it is.

Referring to FIG. 6, the insulating layer 700 may be disposed on the third surface 103 of the body 100, and at least a portion of the insulating layer 700 may be disposed to extend between the third surface 103 of the body 100 and the adhesive layer AL.

That is, in FIG. 6, it is illustrated that the insulating layer 700 covers the entire the third surface 103 of the body 100, but the present disclosure is not limited thereto, a portion of the insulating layer 700 may extend between the third surface 103 of the body 100 and the adhesive layer AL, so that a portion of the adhesive layer AL and the insulating layer 700 may overlap.

For example, the insulating layer 700 may be formed by applying and curing a material containing an insulating resin to a surface of the body 100. In this case, the insulating layer 700 may include at least one of a thermoplastic resin such as polystyrene-based, vinyl acetate-based, polyester-based, polyethylene-based, polypropylene-based, polyamide-based, rubber-based, acrylic-based, and the like, a thermosetting resin such as phenol-based, epoxy-based, urethane-based, melamine-based, alkyd-based resins, and the like, and a photosensitive insulating resin.

The coil component 1000″ according to the present embodiment may reduce a risk of leakage current occurring along the surface of the body 100 between the pad portions 511 and 521.

In addition, as the insulating layer 700 is interposed between the body 100 and the adhesive layer AL, the bonding force may be strengthened as compared to the case in which the adhesive layer AL is directly disposed on the body 100.

### Second Embodiment

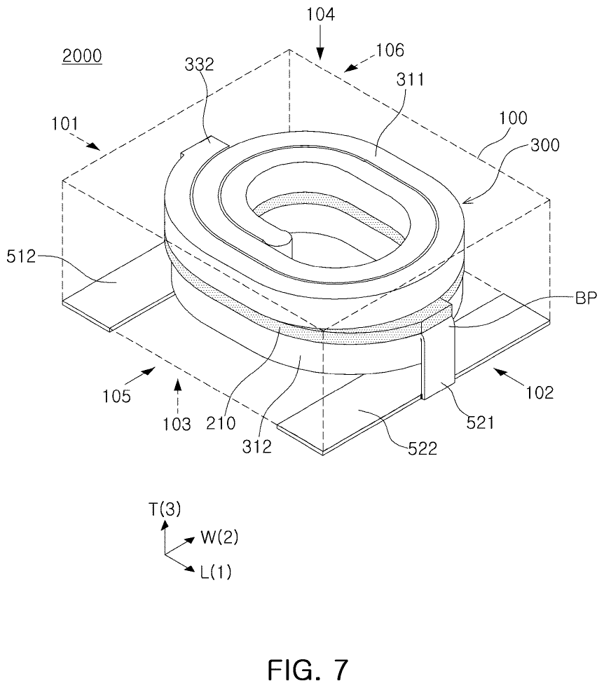

FIG. 7 is a perspective view schematically illustrating a coil component 2000 according to a second embodiment of the present disclosure.

Comparing FIG. 7 with FIG. 1, the shape of the pad portions 512 and 522 of the coil component 2000 according to the present embodiment is different from the first embodiment.

Therefore, in describing the present embodiment, only the first embodiment of the present disclosure and the shapes of the pad portions 512 and 522 will be described, and for the remaining components of the present embodiments, the description in the first embodiment of the present disclosure may be applied as it is.

Referring to FIG. 7, the pad portions 512 and 522 of the coil component 2000 according to the present embodiment may be formed to have a constant width in the second direction (W), and may be formed to have the same width as the body 100.

As a result, the pad portions 512 and 522 of the coil component 2000 according to the present embodiment may have a greater area than that in the first embodiment, and accordingly, since an area in which the first and second electrode portions 510 and 520 surround the body 100 also increases, so that the physical bonding force between the first and second electrode portions 510 and 520 and the body 100 may be further strengthened.

In addition, the coil component 2000 according to the present embodiment may have a large area of the pad portions 512 and 522, so when the coil component 2000 is mounted on a printed circuit board (PCB), direct current resistance (Rdc) generated in the pad portions 512 and 522 may be reduced.

In addition, when forming the first and second electrode portions 510 and 520 in a coil bar state to which a plurality of coils 300 are connected, a design process of the first and second electrode portions 510 and 520 may be further simplified.

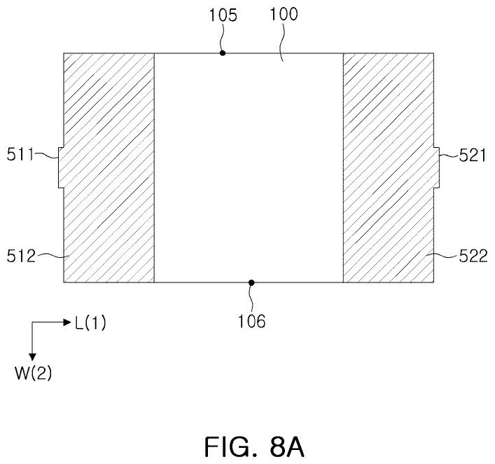

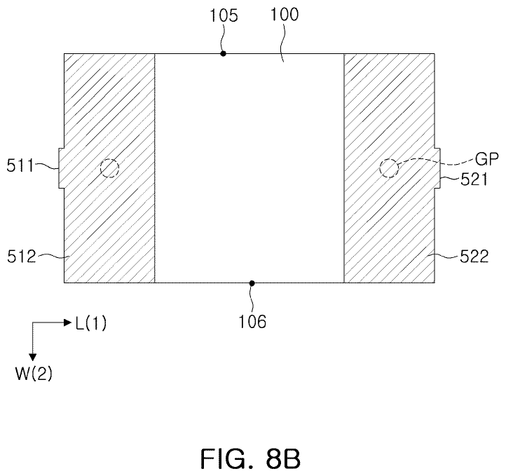

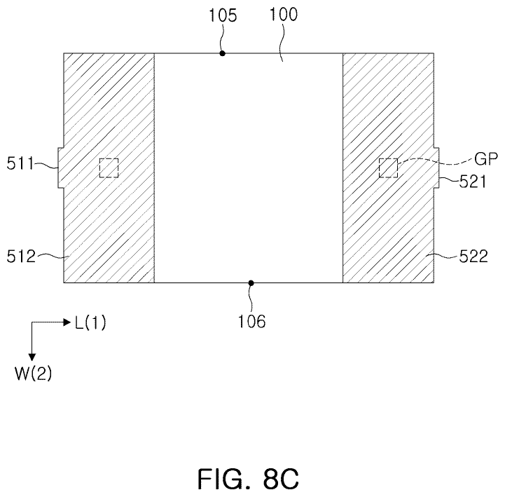

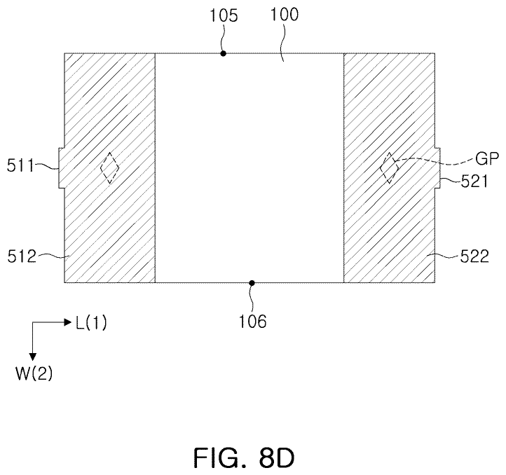

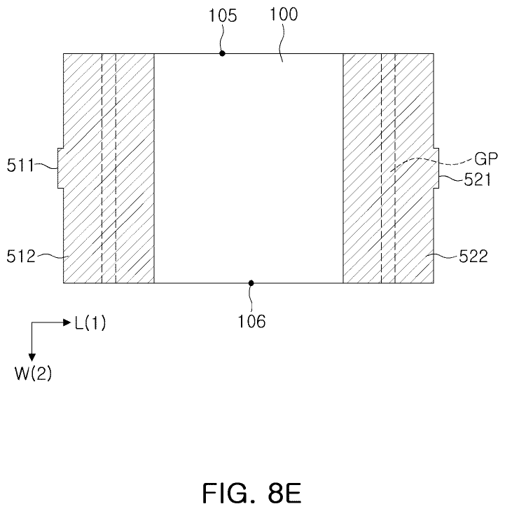

FIG. 8A is a bottom view of FIG. 7, and FIGS. 8B to 8E are modified examples of FIG. 8A.

Referring to FIG. 8A, the pad portions 512 and 522 of the present embodiment may have an overall flat outer surface.

However, the scope of the present disclosure is not limited thereto, and the pad portions 512 and 522 may have at least one groove portion GP formed on the outer surface, and the groove portion GP may be modified into various forms as follows.

Referring to FIG. 8B, the groove portion GP may have a circular shape based on the L-W cross section.

In addition, referring to FIG. 8C, the groove portion GP may have a square shape based on the L-W cross section.

In addition, referring to FIG. 8D, the groove portion GP may have a diamond shape based on the L-W cross section.

In addition, referring to FIG. 8E, the groove portion GP may have a straight line shape in the second direction based on the L-W cross section.

The groove portion GP may be formed as a perforation to penetrate the pad portions 512 and 522, but the present disclosure is not limited thereto, and the groove portion GP may be formed in a form into which the groove portion GP region is recessed, while not penetrating the pad portions 512 and 522.

As in the present embodiment and the modified examples, when the pad portions 512 and 522 have at least one groove portion GP, a surface area of the outer surfaces of the pad portions 512 and 522 may be increased, so that the bonding force may be strengthened when mounted on a printed circuit board (PCB).

In addition, when the groove portion GP is formed to penetrate the pad portions 512 and 522, the groove portion GP may be filled with a bonding member such as solder when mounted on a printed circuit board (PCB), so that the bonding force may be increased and component rotation may be prevented.

### Third Embodiment

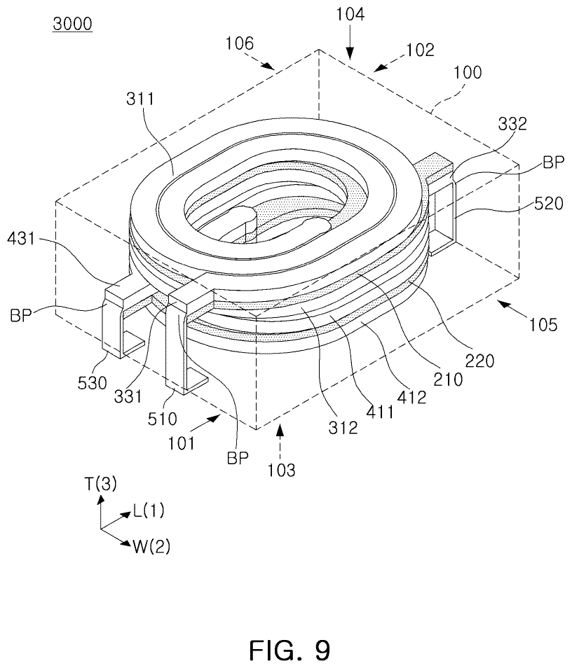

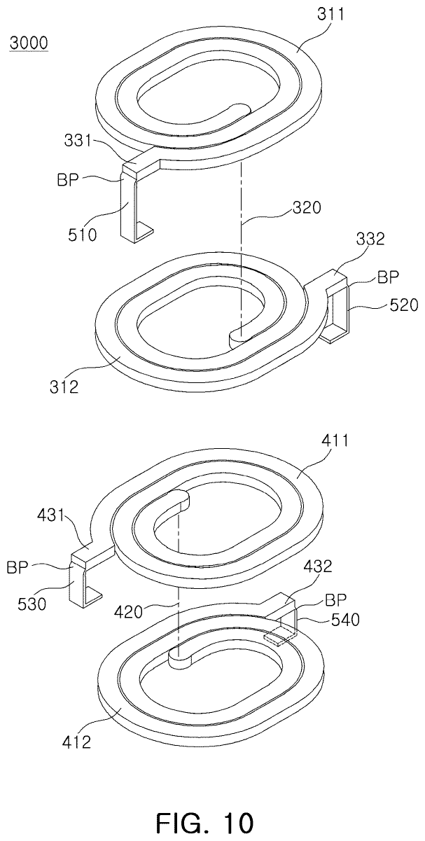

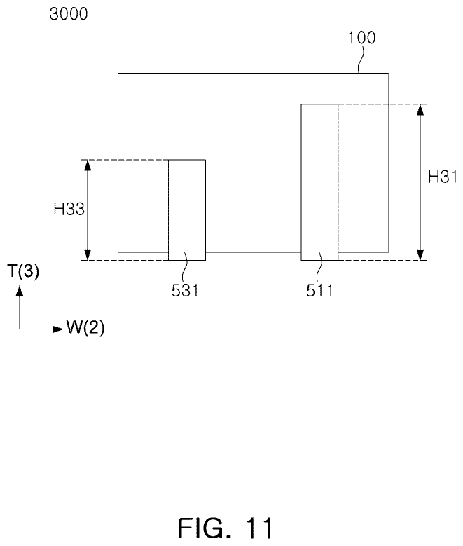

FIG. 9 is a perspective view schematically illustrating a coil component 3000 according to a third embodiment of the present disclosure. FIG. 10 is an exploded perspective view illustrating a connection relationship between the coils 300 and 400 of FIG. 9. FIG. 11 is a left side view of FIG. 9. FIG. 12 is a right side view of FIG. 9.

Comparing FIG. 9 with FIG. 1, components of the coils 300 and 400, the support members 210 and 220, and the electrode portions 510, 520, 530, and 540 are different. That is, the coil component 3000 may further include a second coil 400, a second support member 220, a third electrode portion 530, and a fourth electrode portion 540.

Therefore, in describing the present embodiment, only the second coil 400, the second support member 220, the third electrode portion 530, and the fourth electrode portion 540, which are different from those of the first embodiment, and a connection relationship between the components will be described, and the description in the first embodiment of the present disclosure may be applied as it is to the remaining components of the present embodiments.

Referring to FIGS. 9 and 10, the coil component 3000 according to the present embodiment may include a first coil 300 and a second coil 400 that can be magnetically coupled when energized.

A magnitude of a coupling coefficient k may be adjusted depending on an interval between the first coil 300 and the second coil 400, and a sign of mutual inductance may be determined depending on a winding direction of the first coil 300 and the second coil 400.

In the case of the coil component 3000 according to the present embodiment, the first coil 300 and the second coil 400 may be wound in opposite directions, but the present disclosure is not limited thereto, and may be wound in the same direction.

Referring to FIGS. 9 and 10, a first coil pattern 311 and a second coil pattern 312 may be disposed on both surfaces of the first support member 210, respectively, and the first coil pattern 311 and the second coil pattern 312 may be connected by a first via 320 penetrating the first support member 210.

Likewise, a third coil pattern 411 and a fourth coil pattern 412 may be disposed on both surfaces of the second support member 220, respectively, and the third coil pattern 411 and the fourth coil pattern 412 may be connected by a second via 420 penetrating the second support member 220.

Each of the first to fourth electrode portions 510, 520, 530, and 540 may extend externally of the first to fourth lead-out portions 331, 332, 431, and 432 and be bent toward the three surface 103 of the body 100.

Referring to FIGS. 11 and 12, each of the electrode portions 510, 520, 530, and 540 of the coil component 3000 according to the present embodiment may include extension portions 511, 521, 531, and 541 and pad portions 512, 522, 532, and 542, and an average length of each of the first to fourth extension portions 511, 512, 513, and 514 may be formed to be different from each other.

Specifically, an average length H31 of the first extension portion 511 illustrated in FIG. 11 may be longer than an average length H33 of the third extension portion 531.

In addition, an average length H32 of the second extension portion 521 illustrated in FIG. 12 may be longer than an average length H34 of the fourth extension portion 541.

In addition, referring to FIGS. 9 to 12, the average lengths H31, H32, H33, and H34 of each of the first to fourth extensions 511, 521, 531, and 541 may satisfy H31>H32>H33>H34.

### Manufacturing Process of Coil Component

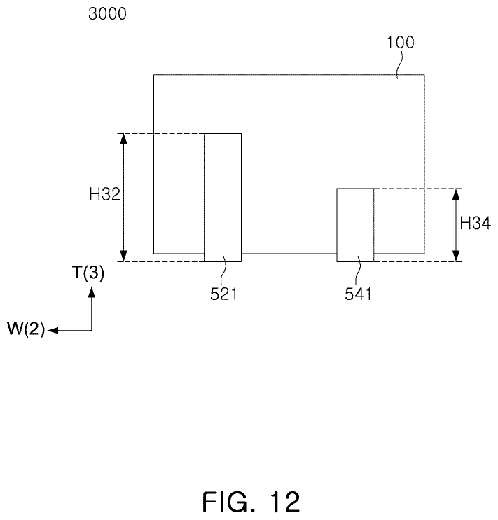

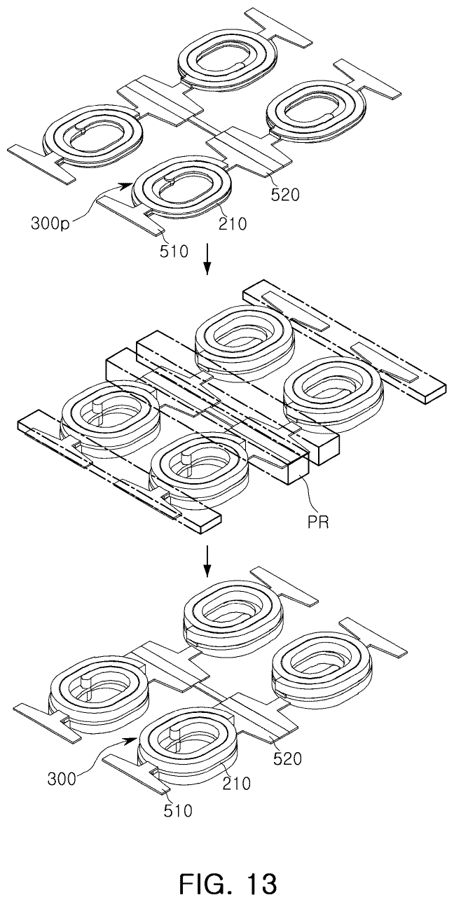

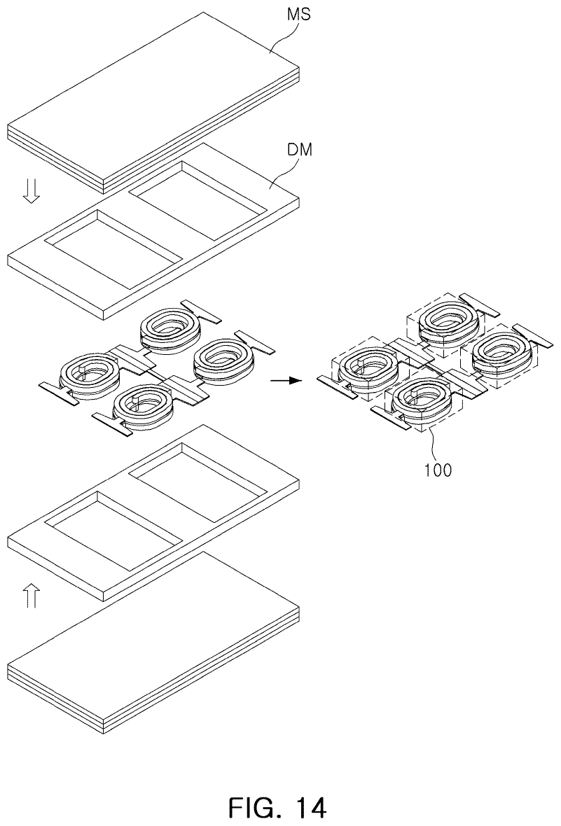

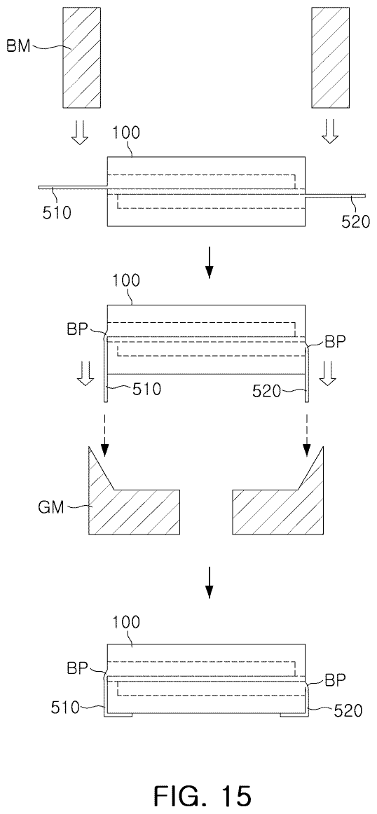

FIGS. 13 to 15 are process charts schematically illustrating a step-by-step manufacturing process of a coil component according to a first embodiment of the present disclosure, and FIG. 13 is a process diagram schematically illustrating an operation for forming a coil component according to a first embodiment of the present disclosure. FIG. 14 is a process diagram schematically illustrating an operation of forming a body of the coil component according to the first embodiment of the present disclosure. FIG. 15 is a process diagram schematically illustrating a bending operation of an electrode portion of the coil component according to the first embodiment of the present disclosure.

The process according to the present embodiment may be performed in a state of a coil bar to which a plurality of coils 300 are connected, and a bending process of the first and second electrode portions 510 and 520 may be performed on an individual component basis after dicing.

Referring to FIG. 13, first, a thin coil 300P and first and second electrode portions 510 and 520 may be formed on both surfaces of the support member 210 through primary plating to the thickness of the first and second electrode portions 510 and 520.

Next, plating resist may be disposed only on the first and second electrode portions 510 and 520, and then only the coil pattern may be grown to a desired thickness through secondary plating.

Next, when the plating resist that has completed a role of dam masking is removed, a structure in which the coil 300 and the thin electrode portions 510 and 520 are integrated may be implemented.

Referring to FIG. 14, dummy members DM may be disposed above and below the coil 300 and the first and second electrode portions 510 and 520 implemented in FIG. 13, and magnetic sheet MS may be compressed and hardened in a vertical direction to form a body 100. Thereafter, a coil component 1000 with the thin electrode portions 510 and 520 exposed may be obtained in individual component units through a dicing process.

Referring to FIG. 15, pressure may be applied to the first and second electrode portions 510 and 520 of the coil component obtained in FIG. 10 through the bending member BM downwardly, so that the first and second electrode portions 510 and 520 may be bent to be into close contact with a side surface of the body 100.

Next, the first and second electrode portions 510 and 520 may be disposed on a guide member GM, and applied pressure downwardly, to bend the first and second electrode portions 510 and 520 once more, to bring the first and second electrode portions 510 and 520 into close contact with a lower surface of the body 100.

Through the above manufacturing process, the coil component 1000 according to the first embodiment of the present disclosure may be implemented.

As set forth above, according to an aspect of the present disclosure, the reliability of a connection between the coil and the external electrode may be maintained within the coil component despite vibrations or external impacts.

According to another aspect of the present disclosure, the physical bonding force between the electrode portion and the body may be strengthened by a structure in which the electrode portion is bent to surround the body.

While example embodiments have been illustrated and described above, it will be apparent to those skilled in the art that modified examples and variations could be made without departing from the scope of the present disclosure as defined by the appended claims.

What is claimed is:

1. A coil component, comprising:
a body including a first surface and a second surface facing each other in a first direction, and a third surface connecting the first surface and the second surface;
a support member disposed within the body;
a coil disposed on the support member, and including a coil pattern having at least one turn and a lead-out portion extending from an outer end of the coil pattern to the first surface or the second surface; and
an electrode portion extending from the lead-out portion externally of the body and disposed on the body, and having an average thickness smaller than an average thickness of the lead-out portion.

2. The coil component of claim 1, wherein the electrode portion is integrally formed with the lead-out portion.

3. The coil component of claim 1, wherein the electrode portion is directly connected to the lead-out portion and comprises an extension portion disposed on the first surface or the second surface, and a pad portion disposed on the third surface.

4. The coil component of claim 3, wherein the extension portion comprises a bent portion, bent toward the third surface in a region in contact with the lead-out portion, and
an outer surface of the bent portion includes a curved surface.

5. The coil component of claim 3, wherein the extension portion has a constant width in a second direction, perpendicular to the first direction.

6. The coil component of claim 3, wherein a width of the extension portion in a second direction, perpendicular to the first direction, is maximum in a region in contact with the pad portion.

7. The coil component of claim 3, wherein a width of the extension portion in a second direction, perpendicular to the first direction, is minimum in a region in contact with the pad portion.

8. The coil component of claim 3, wherein a width of the extension portion in a second direction, perpendicular to the first direction, is maximum in a central region of the extension portion.

9. The coil component of claim 3, wherein a width of the pad portion in a second direction, perpendicular to the first direction, is maximum in a region most adjacent to a center of the third surface.

10. The coil component of claim 9, wherein the width of the pad portion in the second direction is greater toward the center of the third surface.

11. The coil component of claim 9, wherein the width of the pad portion in the second direction is minimum in a region in contact with the extension portion.

12. The coil component of claim 3, wherein at least one groove portion is formed on an outer surface of the pad portion.

13. The coil component of claim 12, wherein the at least one groove portion penetrates through the pad portion.

14. The coil component of claim 3, wherein an adhesive layer is disposed between the pad portion and the third surface.

15. The coil component of claim 14, wherein the adhesive layer includes epoxy.

16. The coil component of claim 14, wherein the adhesive layer includes a plurality of layers.

17. The coil component of claim 14, wherein an insulating layer is disposed on the third surface, and at least a portion of the insulating layer extends between the third surface and the adhesive layer.

18. The coil component of claim 3, wherein the electrode portion further comprises a first metal layer disposed on the pad portion.

19. The coil component of claim 18, wherein the electrode portion further comprises a second metal layer disposed on the first metal layer.

20. The coil component of claim 1, wherein the average thickness of the electrode portion is smaller than an average thickness of the support member.

21. The coil component of claim 1, wherein the coil pattern comprises a first coil pattern disposed on one surface of the support member, and a second coil pattern disposed on another surface of the support member,
the lead-out portion comprises a first lead-out portion extending from the first coil pattern toward the first surface, and a second lead-out portion extending from the second coil pattern toward the second surface,
the electrode portion comprises a first electrode portion extending from the first lead-out portion and disposed on the first surface, and a second electrode portion extending from the second lead-out portion and disposed on the second surface, and
each of the first electrode portion and the second electrode portion further extends onto the third surface.

22. The coil component of claim 21, wherein the first electrode portion is directly connected to the first lead-out portion, and comprises a first extension portion disposed on the first surface and a first pad portion disposed on the third surface,
the second electrode portion is directly connected to the second lead-out portion, and comprises a second extension portion disposed on the second surface and a second pad portion disposed on the third surface,
an average length of the first extension portion between the first lead-out portion and the first pad portion is different from an average length of the second extension portion between the second lead-out portion and the second pad portion.

23. The coil component of claim 22, wherein the average length of the first extension portion between the first lead-out portion and the first pad portion is longer than the average length of the second extension portion between the second lead-out portion and the second pad portion.

24. A coil component, comprising:
a body;
a first coil and a second coil disposed within the body and having at least one turn;
a first electrode portion and a second electrode portion extending from both ends of the first coil externally of the body, respectively, and disposed on the body; and
a third electrode portion and a fourth electrode portion extending from both ends of the second coil externally of the body, respectively, and disposed on the body,
wherein an average thickness of each of the first electrode portion and the second electrode portion is smaller than an average thickness of the first coil, and
an average thickness of each of the third electrode portion and the fourth electrode portion is smaller than an average thickness of the second coil.

25. The coil component of claim 24, wherein the first coil and the second coil are spaced apart from each other, and wound in opposite directions.

26. The coil component of claim 24, wherein the first electrode portion and the second electrode portion are integrally formed with the first coil, and
the third electrode portion and the fourth electrode portion are integrally formed with the second coil.

27. The coil component of claim 24, wherein the body comprises a first surface and a second surface, facing each other in a first direction, and a third surface connecting the first surface and the second surface,
each of the first electrode portion and the third electrode portion is disposed on the first surface and extends onto the third surface, and
each of the second electrode portion and the fourth electrode portion is disposed on the second surface and extends onto the third surface.

28. The coil component of claim 27, wherein an average length of each of the first electrode portion and the third electrode portion disposed on the first surface is different from each other, and
an average length of each of the second electrode portion and the fourth electrode portion disposed on the second surface is different from each other.

29. The coil component of claim 24, further comprising:
at least one of a first support member on which the first coil is disposed; and
a second support member on which the second coil is disposed.

30. A coil component, comprising:
a body;
a support member disposed within the body;
a coil disposed on the support member within the body and having at least one turn; and
an electrode portion extending from a lead-out portion of the coil externally of the body and disposed on an external surface of the body to function as an external electrode,
wherein the electrode portion includes a reduced thickness portion at the one end of the coil, and
the electrode portion is integrally formed with the lead-out portion.

31. The coil component of claim 30, wherein an average thickness of the electrode portion is smaller than an average thickness of the lead-out portion.

32. The coil component of claim 30, wherein the electrode portion is disposed on two continuous surfaces of the body.

33. The coil component of claim 30, wherein the body comprises a first surface and a second surface, facing each other in a first direction, and a third surface connecting the first surface and the second surface, and
the electrode portion comprises an extension portion disposed on the first surface or the second surface, and a pad portion disposed on the third surface.

34. The coil component of claim 33, wherein the extension portion has a constant width in a second direction perpendicular to the first direction,
a width of the pad portion in the second direction gradually increases toward a center of the third surface of the body, and
a portion of the pad portion having a minimum width in the second direction is spaced apart from the first surface or the second surface.

35. The coil component of claim 34, wherein the extension portion further extends onto the third surface.

36. The coil component of claim 33, wherein the extension portion is in contact with an exposed surface of the support member.
